(19) United States
(12) Patent Application Publication
(10) Pub. No.: US 2016/0074796 A1
(43) Pub. Date: Mar. 17, 2016

(54) FILTER ELEMENT

(71) Applicant: Carl Freudenberg KG, Weinheim (DE)

(72) Inventors: Maik Sieh, Sandhausen (DE); Siegfried Sonn, Hemsbach (DE); Juergen Klaus, Hemsbach (DE); Juergen Becker, Zeiskam (DE); Guenther Beck, Lampertheim (DE)

(21) Appl. No.: 14/848,367

(22) Filed: Sep. 9, 2015

(30) Foreign Application Priority Data
Sep. 12, 2014 (EP) 14 003 165.9

(51) Int. Cl. B01D 46/00

(52) U.S. Cl. CPC B01D 46/0005

(57) ABSTRACT

A filter element has an, as far as possible, long-term connection between a seal and the frame of the filter element, a filter element having a frame which is assigned a seal is wherein the frame is assigned a mount , in which the seal is accommodated, and fixed, in a form-fitting manner.

### CROSS-REFERENCE TO RELATED APPLICATIONS

Priority is claimed to European Patent Application No. 14 003 165.9, filed on Sep. 12, 2014, the entire disclosure of which is hereby incorporated by reference herein.

### FIELD

The invention relates to a filter element.

### BACKGROUND

The prior art discloses cassette filters for high-temperature applications having sheet-metal frames or aluminum-profile frames.

For the purpose of sealing the filter cassettes in relation to an accommodating wall in a filter installation, use is currently made of glass-cord seals. The glass-cord seals are adhesively bonded to the filter cassette.

Once the filter cassettes have been used for a relatively long period of time at high temperatures, in particular at temperatures which are higher than 150° C., the adhesive bond can loosen.

Furthermore, the task of applying the adhesive during production of the filter cassettes involves relatively high outlay.

### SUMMARY

An aspect of the invention provides a filter element, comprising: a frame which is assigned a seal, wherein the frame is assigned a mount, and wherein the seal is accommodated, and fixed, in a form-fitting manner, in the mount.

### BRIEF DESCRIPTION OF THE DRAWING

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a sectional view of an extruded profile and a perspective view of the seal,

FIG. 2 shows a sectional view of the extruded profile according to FIG. 1 with the seal accommodated in a form-fitting manner,

FIG. 3 shows a perspective view of the extruded profile according to FIG. 2 with the seal accommodated in a form-fitting manner, and

FIG. 4 shows a filter element having a frame in which the seal is accommodated.

### DETAILED DESCRIPTION

Against this background, the object on which the invention is based is that of specifying a filter element in which there is an, as far as possible, long-term connection between a seal and the frame of the filter element.

It has been found in the first instance, according to the invention, that an adhesive bond between a seal and a frame of a filter cassette is not stable over the long term at high temperatures. To this extent, it is no longer possible for the filter cassette, after long-term use at high temperatures, to butt with sufficient sealing action against an accommodating wall. It has also been found, according to the invention, that accommodating the seal in a form-fitting manner gives rise to a mechanical connection between the seal and the frame. Surprisingly, this connection also withstands relatively high temperatures over the long term. To this extend, the filter element specified is one in which there is an, as far as possible, long-term connection between a seal and the frame of the filter element, it being possible for the connection to be established straightforwardly.

The mount could be formed in an extruded profile, which forms the frame. An extruded profile can be produced cost-effectively and in a variety of dimensions.

The mount could be formed in a metal frame. In contrast to an extruded profile, a metal frame or sheet-metal frame is an individually produced component. This component, however, may be produced from a large number of materials. For example, a thin metal sheet is easy to deform and to machine. In contrast, an extruded profile has a set shape or form.

The extruded profile could be designed in the form of a keder rail, in which the seal is accommodated. A keder rail makes possible a tried-and-tested form-fitting connection.

The seal could be designed in the form of an extrusion which is accommodated in a form-fitting manner in the mount. An extrusion, for example a glass cord, can easily be provided with a certain profile.

The mount for the seal could be arranged on the raw-gas side and/or clean-gas side. This allows for various installation variants.

The filter element is preferably configured in the form of a cassette filter. Cassette filters can be used in environments in which high temperatures prevail. The extruded profile with mount, that is to say the keder rail, can be used for making cassette filters for high-temperature applications. One area in which these cassette filters is used is that of air filtration in temperatures ranging from greater than 100° C. to a maximum of 385° C. Specifically, it is conceivable for these cassette filters to be used in paintwork-drying processes in the automotive industry.

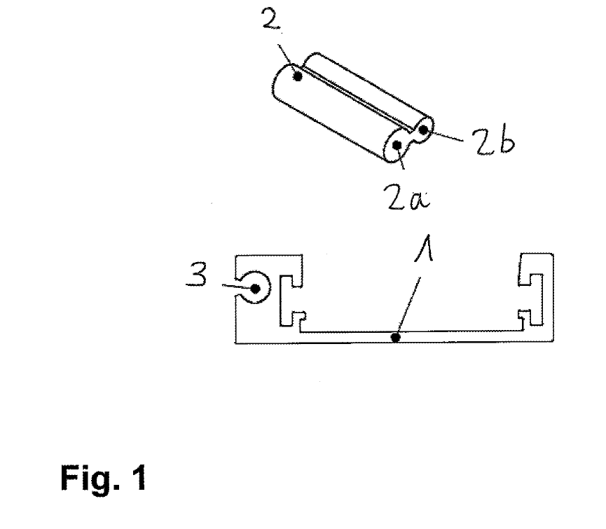

FIG. 1 shows a sectional view of an extruded profile 1 and a perspective view of a seal 2. The seal 2 is designed in the form of an extrusion which can be accommodated in a form-fitting manner in a mount 3. The extruded profile 1 is designed in the form of a keder rail.

The extrusion has two at least partially cylindrical portions 2a, 2b, of which one can be accommodated in a form-fitting manner in the mount 3, the other butting with sealing action against an accommodating wall (not shown) of a filter installation.

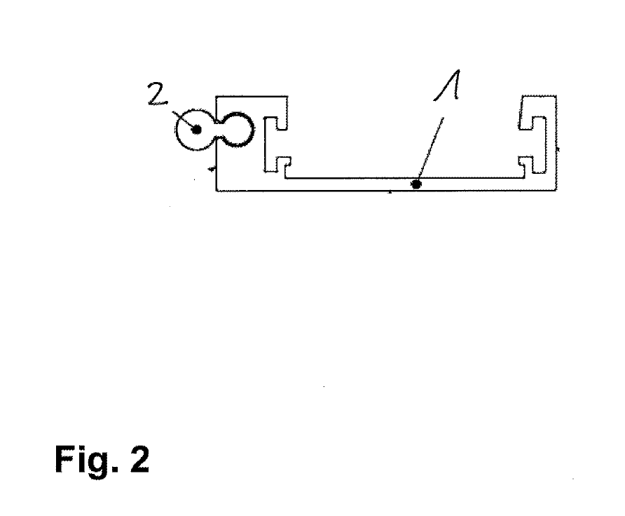

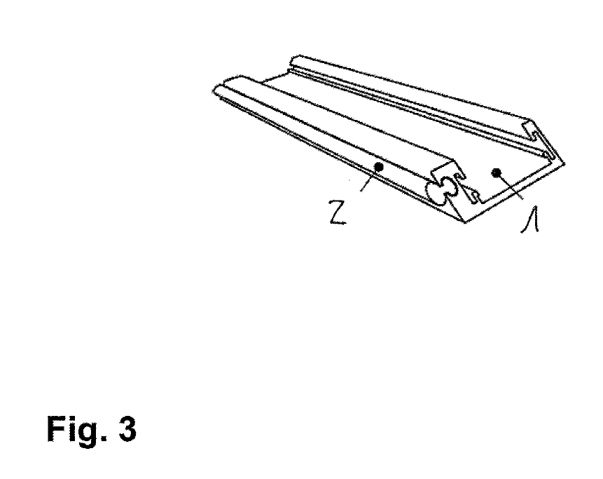

FIG. 2 shows a sectional view of the extruded profile 1 according to FIG. 1 with the seal 2 accommodated in a form-fitting manner. FIG. 3 shows a perspective view of the extruded profile 1 according to FIG. 2 with the seal 2 accommodated in a form-fitting manner.

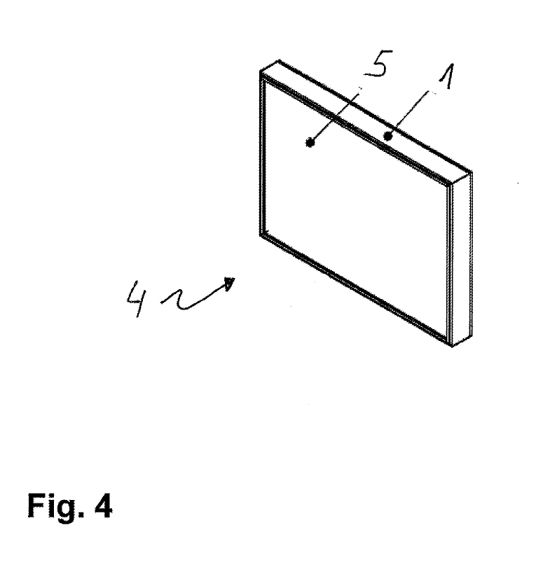

FIG. 4 shows a filter element 4 comprising a frame, which is designed in the form of an extruded profile 1, wherein the frame is assigned a seal 2. The frame, that is to say the extruded profile 1, is assigned a mount 3, in which the seal 2 is accommodated, and fixed, in a form-fitting manner. This is shown in FIGS. 1 to 3.

The mount 3 is formed in an extruded profile 1, which forms the frame. The extruded profile 1 is designed in the form of a keder rail made of aluminum, in which the seal 2 is accommodated.

The seal 2 is designed in the form of an extrusion which is accommodated in a form-fitting manner in the mount 3.

The mount 3 for the seal 2 is arranged on the clean-gas side.

The filter element 4 has a folding bellows 5, which is enclosed by the frame.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A filter element, comprising:
a frame;
a seal assigned to the frame; and
a mount assigned to the frame, wherein the seal is accommodated, and fixed, in a form-fitting manner, in the mount.

2. The filter element of claim 1, wherein the mount is formed in an extruded profile, which forms the frame.

3. The filter element of claim 1, wherein the mount is formed in a metal frame.

4. The filter element of claim 2, wherein the extruded profile has a form of a keder rail, in which the seal is accommodated.

5. The filter element of claim 1, wherein the seal has a form of an extrusion which is accommodated in a form-fitting manner in the mount.

6. The filter element of claim 1, wherein the mount is arranged on a raw-gas side, clean-gas side, or raw-gas and clean-gas side of the filter element.

7. The filter element of claim 1, wherein the mount for the seal is arranged on a raw-gas side of the filter element.

8. The filter element of claim 1, wherein the mount for the seal is arranged on a raw-clean-gas side of the filter element.

9. The filter element of claim 1, wherein the mount is arranged on a raw-gas side and a clean-gas side of the filter element.

10. The filter element of claim 1, configured in the form of a cassette filter.
